(19) United States
(12) Patent Application Publication
(10) Pub. No.: US 2025/0373078 A1
(43) Pub. Date: Dec. 4, 2025

(54) MULTIFUNCTIONAL MOBILE POWER PACK WITH TRACKING FUNCTION

(71) Applicant: Shangxiong YANG, Shenzhen (CN)

(72) Inventor: Shangxiong YANG, Shenzhen (CN)

(21) Appl. No.: 18/984,881

(22) Filed: Dec. 17, 2024

(30) Foreign Application Priority Data
May 28, 2024 (CN) 202421199411.3

(51) Int. Cl. H02J 50/10; H01M 10/46; H02J 7/00; H02J 50/00; H02J 50/90

(52) U.S. Cl. CPC H02J 50/10; H01M 10/46; H02J 50/005; H02J 50/90; H01M 2220/30; H02J 7/0047

(57) ABSTRACT

The utility model discloses a multifunctional mobile power pack with a tracking function, including a mobile power pack body and a card holder assembly. A wireless charging module and a position tracking module are disposed in the mobile power pack body, and the card holder assembly is rotatably connected to the mobile power pack body. In the utility model, as the card holder assembly for placing important cards such as bank cards is disposed on the mobile power pack body, the mobile power pack body and the cards are placed together and convenient for the user to carry. The wireless charging module of the mobile power pack body supplies power to a phone and includes a built-in position tracking module that can quickly locate the mobile power pack in case of loss.

### TECHNICAL FIELD

The utility model relates to the technical field of intelligent energy storage devices, and more specifically, to a multifunctional mobile power pack with a tracking function.

### BACKGROUND

The mobile power bank is a portable charging apparatus and an energy storage device that integrate power supply and charging functions, allowing phones and other digital devices to be charged or supplied with power anytime and anywhere. Polymer lithium-ion cells are typically used as the energy storage carrier. It, unlike a battery configured in a product, is also called mobile power or an external battery. The charging plug of the power bank can directly charge a mobile device via an alternating current power source and has its own energy storage means, acting as a mixture of a charger and a backup battery. Compared with a backup power source, it can simplify the means of the charging plug, and compared with a charger, it has its own energy storage means, providing backup power for a digital product when there is no direct current power source or when the user is outdoor.

With the widespread use of electronic products, the power bank has become an essential energy storage device in people's daily lives, especially during travel.

However, in modern life, people carry not only power banks during travel but also important cards such as ID cards and bank cards. People usually put the power banks in their backpacks and the cards in their wallets or pockets. This separate placement manner, however, causes inconvenient taking out in need of use. When people need to charge or use the cards, they need to rummage through their backpacks, wallets, and pockets, which not only wastes time but also is likely to lead to losing items in a hurry. Because important cards such as bank cards are thin and easily bent, after use, they are often casually put back into pockets or bags and forgotten to be returned to the safe place, and thus are likely to slip off the pockets or bags unintentionally and lost.

### SUMMARY OF THE UTILITY MODEL

To overcome the current inconvenience of taking out the power bank and cards that are separately stored, and resolve the problem that the thin cards, after use, are likely to be placed casually, for example, at corners of pockets or bags, increasing the loss risk, the utility model provides a multifunctional mobile power pack with a tracking function.

The technical solutions of the utility model are described as follows.

A multifunctional mobile power pack with a tracking function is provided, including:
a mobile power pack body, where a wireless charging module and a position tracking module are disposed in the mobile power pack body, and
a card holder assembly disposed on the mobile power pack body, where the card holder assembly is rotatably connected to the mobile power pack body, such that the card holder assembly and the mobile power pack body form an included angle so as to support the mobile power pack body.

According to the above solution of the utility model, the wireless charging module includes:
a control mainboard and a battery, where the control mainboard is electrically connected to the battery;
a wireless transmitting coil, where the wireless transmitting coil is electrically connected to the control mainboard to form a wireless transmitting terminal; and
a magnet ring, where the magnet ring is located at an outer periphery of the wireless transmitting coil, such that a position of the coil is identified automatically through magnetic attraction.

According to the above solution of the utility model, the position tracking module includes a positioning function mainboard and a buzzer, the positioning function mainboard is connected to the buzzer, and the positioning function mainboard and the buzzer are both connected to the control mainboard.

According to the above solution of the utility model, the card holder assembly has a storage slot, and the storage slot is used for storing a card.

According to the above solution of the utility model, the mobile power pack body is provided with a first hinge structure, the card holder assembly is provided with a second hinge structure fitting with the first hinge structure, and the first hinge structure fits with the second hinge structure, thus achieving rotary connection between the mobile power pack body and the card holder assembly, such that the mobile power pack body and the card holder assembly are capable of rotating relative to each other.

According to the above solution of the utility model, the first hinge structure and the second hinge structure are each provided with a damping member, to enhance frictional force at the first hinge structure and at the second hinge structure, such that during rotation the mobile power pack body and the card holder assembly stop at any angle.

According to the above solution of the utility model, the mobile power pack body is provided with a first chamber and a second chamber, the first chamber is used for accommodating the wireless charging module, and the second chamber is used for accommodating the position tracking module.

According to the above solution of the utility model, the mobile power pack body is further provided with an input and output interface, the input and output interface is connected to the control mainboard, a housing of the mobile power pack body is provided with an interface hole, and the interface hole is used for the input and output interface to extend out of the housing of the mobile power pack body.

According to the above solution of the utility model, the mobile power pack body is further provided with a power indicator light strip, the power indicator light strip is connected to the control mainboard, a housing of the mobile power pack body is provided with a light strip hole, and the light strip hole is used for the power indicator light strip to extend out of the housing of the mobile power pack body.

According to the above solution of the utility model, the mobile power pack body is further provided with a switch button, the switch button is connected to the control mainboard, a housing of the mobile power pack body is provided with a button hole, and the button hole is used for the switch button to extend out of the housing of the mobile power pack body.

According to the foregoing solutions, the utility model has the following beneficial effects: As the card holder assembly is disposed on the mobile power pack body, where the card holder assembly is used for placing important cards such as bank cards, the mobile power pack body and the cards can be placed together and convenient for the user to carry. The wireless charging module of the mobile power pack body is used to supply power to a phone and includes a built-in position tracking module, such that the multifunctional mobile power pack can be quickly located and found after lost. The mobile power pack body and the card holder assembly are rotatably connected at a rotary angle of 0-180°. After opened, the card holder assembly can be used as a phone stand. When a card is to be used, the card holder assembly only needs to be rotated to a suitable angle without taking out the card. This combines charging, card storage, and position tracking functions, providing the user with a more convenient and secure experience.

### DESCRIPTION OF DRAWINGS

FIG. 1 is a schematic structural diagram of the utility model in a state.

FIG. 2 is a schematic structural diagram of the utility model in another state.

FIG. 3 is a schematic structural diagram of the utility model in still another state.

FIG. 4 is a schematic structural exploded view of FIG. 3.

### REFERENCE SIGNS IN THE ACCOMPANYING DRAWINGS

10. mobile power pack body; 11. wireless charging module; 111. control mainboard; 112. battery; 113. wireless transmitting coil; 114. magnet ring; 12. position tracking module; 121. positioning function mainboard; 122. buzzer; 13. first hinge structure; 14. input and output interface; 15. power indicator light strip; 16. switch button; 20. card holder assembly; 21. storage slot; and 22. second hinge structure.

### DETAILED DESCRIPTION OF EMBODIMENTS

To describe the technical problems resolved by the utility model, technical solutions, and beneficial effects more clearly, the following further describes the utility model in detail with reference to the accompanying drawings and embodiments.

It should be noted that the terms “include” and “have” and any variations thereof in the specification and claims of the utility model are intended to cover non-exclusive inclusion. For example, a process, method, system, product, or device that includes a series of steps or units is not limited to the listed steps or units but optionally includes steps or units not listed, or further optionally includes other steps or units inherent to the process, method, product, or device. The terms such as “dispose” should be understood in their general senses. For example, they may refer to a fixed connection, a detachable connection, or an integral connection, may refer to a mechanical connection or an electrical connection, and may refer to a direct connection, an indirect connection via an intermediate medium, an internal communication between two elements, or an interaction between two elements, unless otherwise specified and defined explicitly. Terms “upper,” “lower,” “left,” “right,” “front,” “rear,” “bottom,” and the like indicate orientations or positions based on the orientations or positions shown in the drawings and are for convenience of description only. They should not be understood as limitations to the technical solutions.

It should be noted that, in modern life, people carry not only power banks during travel but also important cards such as ID cards and bank cards. People usually put the power banks in their backpacks and the cards in their wallets or pockets. This separate placement manner, however, causes inconvenient taking out in need of use. When people need to charge or use the cards, they need to rummage through their backpacks, wallets, and pockets, which not only wastes time but also is likely to lead to losing items in a hurry. As important cards such as bank cards are thin and easily bent, after use, they are often casually put back into pockets or bags and forgotten to be returned to the safe place, and thus are likely to slip off the pockets or bags unintentionally and lost.

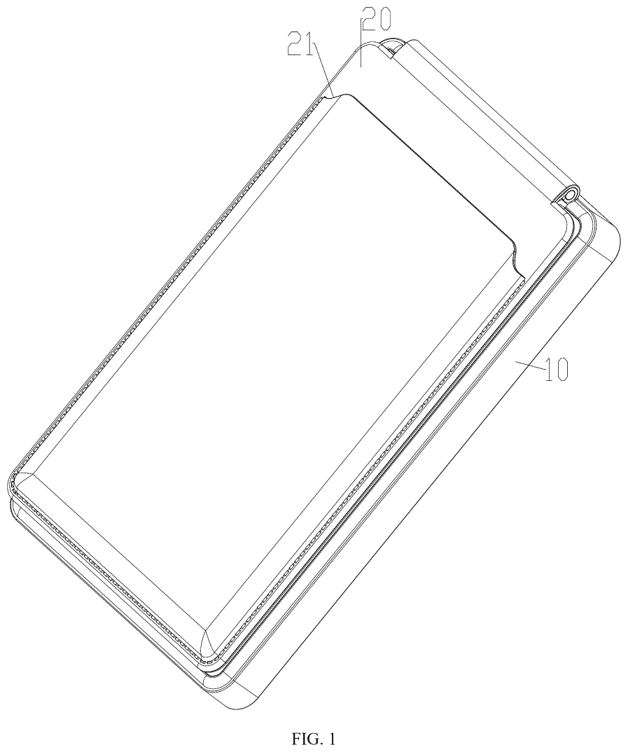

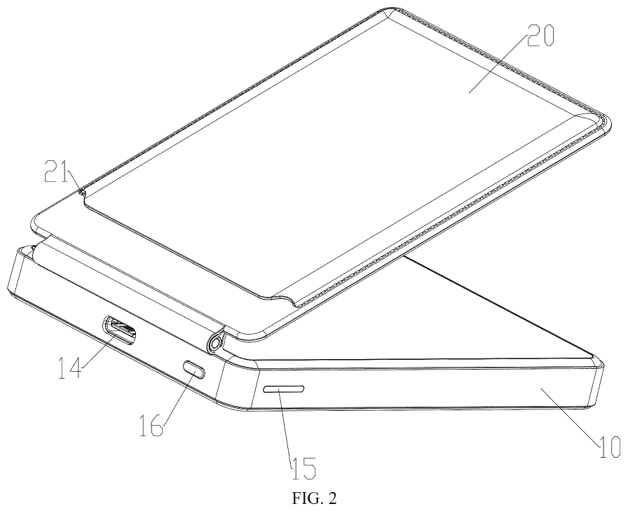

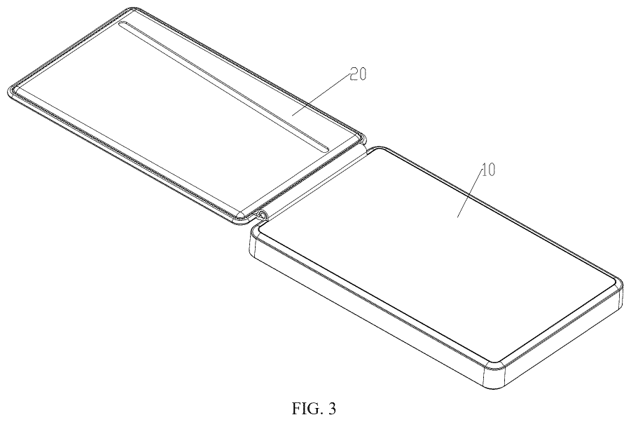

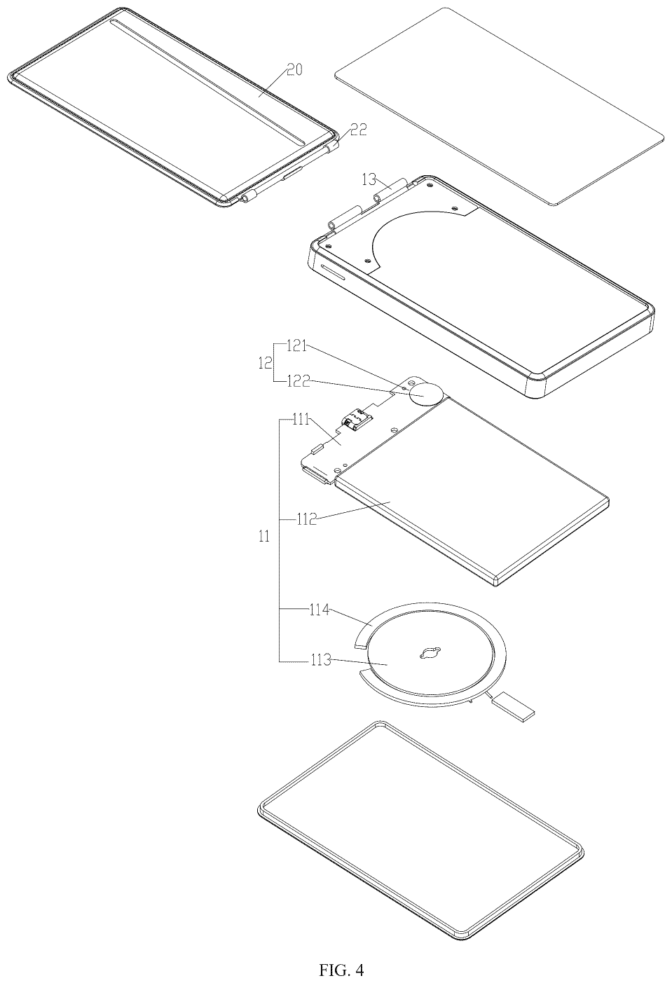

As shown in FIGS. 1 to 4, an embodiment provides a multifunctional mobile power pack with a tracking function. A card holder assembly 20 is disposed on a mobile power pack body 10, where the card holder assembly 20 is convenient for placing important cards such as bank cards, such that the mobile power pack body 10 and the cards are placed together and convenient for the user to carry, avoiding the risk of losing the cards.

The wireless charging module 11 of the mobile power pack body 10 supplies power to a phone and includes a built-in position tracking module 12, such that the multifunctional mobile power pack can be quickly located and found after lost. The mobile power pack body 10 and the card holder assembly 20 are rotatably connected at a rotary angle of 0-180°. After opened, the card holder assembly 20 can be used as a phone stand. When a card is to be used, the card holder assembly only needs to be rotated to a suitable angle without taking out the card.

Specifically, the multifunctional mobile power pack includes a mobile power pack body 10 and a card holder assembly 20 disposed on the mobile power pack body 10. A wireless charging module 11 and a position tracking module 12 are provided in the mobile power pack body 10, and the card holder assembly 20 is rotatably connected to the mobile power pack body 10, such that the card holder assembly 20 and the mobile power pack body 10 form an included angle so as to support the mobile power pack body 10. The multifunctional mobile power pack in this embodiment perfectly combines charging, card storage, and tracking functions, providing the user with a more convenient and secure experience.

In an embodiment, the wireless charging module 11 includes a control mainboard 111, a battery 112, a wireless transmitting coil 113, and the magnet ring 114. The control mainboard 111 is electrically connected to the battery 112; the wireless transmitting coil 113 is electrically connected to the control mainboard 111 to form a wireless transmitting terminal; and the magnet ring 114 is located at an outer periphery of the wireless transmitting coil 113, such that a position of the coil is identified automatically through magnetic attraction. When the mobile power pack body 10 is used to charge a wireless receiving device that also has a magnet, the magnetic attraction between the two magnets automatically engages them, allowing for automatic and accurate positioning with a transmitting coil and a receiving coil and effective fixing of both the transmitting device and the receiving device, thereby improving the conversion efficiency of wireless charging.

In an embodiment, the position tracking module 12 includes a positioning function mainboard 121 and a buzzer 122, the positioning function mainboard 121 is connected to the buzzer 122, and the positioning function mainboard 121 and the buzzer 122 are both connected to the control mainboard 111. Once the mobile power pack is lost, the user can remotely locate it via a mobile App and quickly find the position of the mobile power pack via the sound emitted by the buzzer 122. It should be noted that the positioning function mainboard 121 and the control mainboard 111 may be the same mainboard, and the control mainboard 111 has the function of the positioning function mainboard for positioning and tracking.

In an embodiment, the card holder assembly 20 has a storage slot 21, and the storage slot 21 is used for storing cards, the arrangement of the storage slot 21 allowing for random replacement of cards to be used.

In an embodiment, a precise hinge mechanism is used in the design of the rotary connection to ensure that the card holder assembly 20 remains stable during rotation and can stop at any angle. The user can adjust the angle of the card holder assembly 20 as needed, thereby achieving the function of a mobile phone stand.

Specifically, the mobile power pack body 10 is provided with a first hinge structure 13, the card holder assembly 20 is provided with a second hinge structure 22 fitting with the first hinge structure 13, and the first hinge structure 13 fits with the second hinge structure 22, thus achieving rotary connection between the mobile power pack body 10 and the card holder assembly 20, such that the mobile power pack body 10 and the card holder assembly 20 are capable of rotating relative to each other.

The first hinge structure 13 and the second hinge structure 22 are each provided with a damping member, to enhance frictional force at the first hinge structure 13 and at the second hinge structure 22, such that during rotation the mobile power pack body 10 and the card holder assembly 20 stop at any angle. It should be noted that this embodiment is only a feasible implementation example and should not be construed as limiting this solution. Other solutions where the mobile power pack body 10 and the card holder assembly 20 stop at any angle during rotation are also within the protection scope of the utility model.

In an embodiment, the mobile power pack body 10 is provided with a first chamber and a second chamber, the first chamber is used for accommodating the wireless charging module 11, and the second chamber is used for accommodating the position tracking module 12. The wireless charging module 11 and the position tracking module 12 are respectively placed in the two chambers, reducing interference during use.

In an embodiment, the mobile power pack body 10 is further provided with an input and output interface 14, the input and output interface 14 is connected to the control mainboard 111, a housing of the mobile power pack body 10 is provided with an interface hole, and the interface hole is used for the input and output interface 14 to extend out of the housing of the mobile power pack body 10. The user can charge the multifunctional mobile power pack or supply power to an external device via the input and output interface 14. Preferably, the input and output interface 14 is a Type-C interface.

In an embodiment, the mobile power pack body 10 is further provided with a power indicator light strip 15, the power indicator light strip 15 is connected to the control mainboard 111, a housing of the mobile power pack body 10 is provided with a light strip hole, and the light strip hole is used for the power indicator light strip 15 to extend out of the housing of the mobile power pack body 10. The power indicator light strip 15 is used to display the remaining power of the battery 112, reminding the user to charge in time.

In an embodiment, the mobile power pack body 10 is further provided with a switch button 16, the switch button 16 is connected to the control mainboard 111, a housing of the mobile power pack body 10 is provided with a button hole, and the button hole is used for the switch button 16 to extend out of the housing of the mobile power pack body 10.

It should be understood that those skilled in the art can make improvements or variations based on the above description, and all such improvements and variations should fall within the protection scope of the appended claims of the utility model.

The above has provided an exemplary description of the utility model with reference to the accompanying drawings. It is evident that the implementation of the utility model is not limited to the above methods. Any improvements made using the method concepts and technical solutions of the utility model, or the direct application of the concepts and technical solutions of the utility model to other situations without modification, are within the protection scope of the utility model.

1. A multifunctional mobile power pack with a tracking function, comprising:
a mobile power pack body, wherein a wireless charging module and a position tracking module are disposed in the mobile power pack body, and
a card holder assembly disposed on the mobile power pack body, wherein the card holder assembly is rotatably connected to the mobile power pack body, such that the card holder assembly and the mobile power pack body form an included angle so as to support the mobile power pack body.

2. The multifunctional mobile power pack with a tracking function according to claim 1, wherein the wireless charging module comprises:
a control mainboard and a battery, wherein the control mainboard is electrically connected to the battery;
a wireless transmitting coil, wherein the wireless transmitting coil is electrically connected to the control mainboard to form a wireless transmitting terminal; and
a magnet ring, wherein the magnet ring is located at an outer periphery of the wireless transmitting coil, such that a position of the wireless transmitting coil is identified automatically through magnetic attraction.

3. The multifunctional mobile power pack with a tracking function according to claim 2, wherein the position tracking module comprises a positioning function mainboard and a buzzer, the positioning function mainboard is connected to the buzzer, and the positioning function mainboard and the buzzer are both connected to the control mainboard.

4. The multifunctional mobile power pack with a tracking function according to claim 3, wherein the card holder assembly has a storage slot, and the storage slot is used for storing a card.

5. The multifunctional mobile power pack with a tracking function according to claim 1, wherein the mobile power pack body is provided with a first hinge structure, the card holder assembly is provided with a second hinge structure fitting with the first hinge structure, and the first hinge structure fits with the second hinge structure, thus achieving rotary connection between the mobile power pack body and the card holder assembly, such that the mobile power pack body and the card holder assembly are capable of rotating relative to each other.

6. The multifunctional mobile power pack with a tracking function according to claim 5, wherein the first hinge structure and the second hinge structure are each provided with a damping member, to enhance frictional force at the first hinge structure and at the second hinge structure, such that during rotation the mobile power pack body and the card holder assembly stop at any angle.

7. The multifunctional mobile power pack with a tracking function according to claim 1 wherein the mobile power pack body is provided with a first chamber and a second chamber, the first chamber is used for accommodating the wireless charging module, and the second chamber is used for accommodating the position tracking module.

8. The multifunctional mobile power pack with a tracking function according to claim 2, wherein the mobile power pack body is further provided with an input and output interface, the input and output interface is connected to the control mainboard, a housing of the mobile power pack body is provided with an interface hole, and the interface hole is used for the input and output interface to extend out of the housing of the mobile power pack body.

9. The multifunctional mobile power pack with a tracking function according to claim 2, wherein the mobile power pack body is further provided with a power indicator light strip, the power indicator light strip is connected to the control mainboard, a housing of the mobile power pack body is provided with a light strip hole, and the light strip hole is used for the power indicator light strip to extend out of the housing of the mobile power pack body.

10. The multifunctional mobile power pack with a tracking function according to claim 2, wherein the mobile power pack body is further provided with a switch button, the switch button is connected to the control mainboard, a housing of the mobile power pack body is provided with a button hole, and the button hole is used for the switch button to extend out of the housing of the mobile power pack body.
